(19) United States
(12) Patent Application Publication
(10) Pub. No.: US 2025/0222805 A1
(43) Pub. Date: Jul. 10, 2025

(54) EV CHARGER HOLSTER WITH ADAPTER FOR USE WITH J1772 CONNECTOR

(71) Applicant: EATON INTELLIGENT POWER LIMITED, DUBLIN 4 (IE)

(72) Inventors: Advait Madhusudan Katarki, Pittsburgh, PA (US); Mitchel A. Simmons, Raleigh, NC (US); Saivaraprasad Murahari, Peachtree City, GA (US); Logan Rosevear, Charlotte, NC (US)

(73) Assignee: EATON INTELLIGENT POWER LIMITED, DUBLIN 4 (IE)

(21) Appl. No.: 18/404,102

(22) Filed: Jan. 4, 2024

(51) Int. Cl. B60L 53/31; H01R 13/60

(52) U.S. Cl. CPC B60L 53/31; H01R 13/60

(57) ABSTRACT

An improved holster for J1772 connectors at EV charging stations is disclosed. The holster includes a cradle and a J1772 to a non-J1772 adapter. The adapter is structured to be seated in and locked into the cradle, with the J1772 interface accessible by a user. The charging interface of a J1772 connector can be coupled to the adapter's J1772 interface in order to holster the connector when it is not being used. To charge an EV with a J1772 charging port, the connector can simply be removed from the adapter while the adapter remains seated in the cradle. To charge an EV with a non-J1772 charging port, an actuator on the cradle can be can be actuated to lock the adapter onto the connector so that the adapter is removed from the cradle with the connector, with the non-J1772 interface of the adapter accessible to the EV's charging port.

### FIELD OF THE INVENTION

The disclosed concept relates generally to charging stations for electric vehicles (EVs), and more particularly, to holsters for charging connectors for EV charging stations.

### BACKGROUND OF THE INVENTION

With the development of electric vehicle technology, the number of EVs is growing rapidly, and EV charging stations, similar to gas stations, have become more widely available. An EV charging station, also called an electric recharging point, charging point, and EVSE (Electric Vehicle Supply Equipment), is an element in an infrastructure that supplies electric energy for the recharging of electric vehicles, plug-in hybrid electric-gasoline vehicles, or semi-static and mobile electrical units such as exhibition stands. EV charging stations consist generally of a charging box connected to a power supply (e.g. utility power), and a number of chargers/charging connectors connected to the charging box by electrical cables. Each charging connector is structured to connect to a charging port on an EV in order to charge the battery of the EV with power supplied by the charging box.

One commonly used EV charging connector type used in the U.S. and Canada is J1772. As non-J1772 connectors are anticipated to become more widely publicly available in the near future, a number of automotive OEMs (original equipment manufacturers) have indicated an intent to transition to making their EVs compatible with non-J1772 connectors instead of J1772 connectors. As a result, EV charging station hosts face the decision of whether to provide either or both J1772 and non-J1772 charging connectors. In addition, drivers of EVs may be required to always carry an adapter in the event that they are only able to find a charging station that offers the charging connector type that is incompatible with their vehicle's charging port.

There is, therefore, room for improvement in charging stations and in connectors therefor.

### SUMMARY OF THE INVENTION

These needs, and others, are met by embodiments of an improved holster arrangement disclosed herein. The holster arrangement is designed for use with J1772 connectors at EV charging stations and includes a cradle and a J1772 to non-J1772 adapter. The adapter is structured to be seated in and locked into the cradle, with the J1772 interface accessible by a user. The charging interface of a J1772 connector can be coupled to the adapter's J1772 interface in order to holster the connector when it is not being used. To charge an EV with a J1772 charging port, the connector can simply be removed from the adapter while the adapter remains seated in the cradle. To charge an EV with a non-J1772 charging port, an actuator on the cradle can be used to lock the adapter onto the connector so that the adapter is removed from the cradle with the connector, with the non-J1772 interface of the adapter accessible to the EV's charging port. The cradle and adapter are structured such that the adapter can only be either seated within and locked into the cradle or locked onto the connector, such that the adapter cannot be removed from the cradle unless it is coupled to the charging connector, thus preventing vandalism, theft, and/or accidental loss of the adapter. For the EV charging station hosts who only have J1772 connectors, the improved holster arrangement allows the charging station hosts to simply replace their existing prior art holsters with the improved holster arrangement in order to accommodate both J1772-enabled and non-J1772-enabled vehicles.

In one aspect of the disclosed concept, a holster arrangement for use in securing a J1772 connector in place at an EV charging station when the J1772 connector is not being used for charging comprises: a base, a cradle extending from the base, and an adapter structured to be coupled to a charging interface of the J1772 connector. The adapter comprises a J1772 interface and a non-J1772 interface disposed opposite the J1772 interface. The cradle and the adapter are structured to ensure that the adapter is always locked into either a first state or a second state. In the first state, the adapter is seated in and locked into the cradle. In the second state, the adapter is locked onto the J1772 connector. The adapter is structured to enable an electric vehicle with a non-J1772 charging port to be charged by the J1772 connector when the adapter is coupled to the J1772 connector.

In another aspect of the disclosed concept, an EV charging station for charging electric vehicles comprises: a charging box structured to be connected to a power source; a J1772 connector electrically connected to the connector box and structured to charge electric vehicles; and a holster arrangement structured to secure the J1772 connector in place when the J1772 connector is not being used for charging. The holster arrangement comprises: a base, a cradle extending from the base, and an adapter structured to be coupled to a charging interface of the J1772 connector. The adapter comprises a J1772 interface and a non-J1772 interface disposed opposite the J1772 interface. The cradle and the adapter are structured to ensure that the adapter is always locked into either a first state or a second state. In the first state, the adapter is seated in and locked into the cradle. In the second state, the adapter is locked onto the J1772 connector. The adapter is structured to enable an electric vehicle with a non-J1772 charging port to be charged by the J1772 connector when the adapter is coupled to the J1772 connector.

In another aspect of the disclosed concept, an adapter for use with a holster arrangement of an EV charging station comprises a J1772 interface and a non-J1772 interface disposed opposite the J1772 interface, the EV charging station including a J1772 connector, and the holster arrangement being structured to secure the J1772 connector in place when the J1772 connector is not being used for charging. The adapter is structured to cooperate with a cradle of the holster arrangement in order to always be locked into either a first state or second state. In the first state, the adapter is seated in and locked into the cradle. In the second state, the adapter is locked onto the J1772 connector. The adapter is structured to enable an electric vehicle with a non-J1772 charging port to be charged by the J1772 connector when the adapter is coupled to the J1772 connector.

### BRIEF DESCRIPTION OF THE DRAWINGS

A full understanding of the invention can be gained from the following description of the preferred embodiments when read in conjunction with the accompanying drawings in which:

FIG. 1 is a schematic depiction of an EV charging station that includes a generic holster for a J1772 EV charging connector;

FIG. 2 is a perspective view of a prior art holster for a J1772 EV connector that can be used in the charging station shown in FIG. 1;

FIG. 3 is a perspective view of an improved holster arrangement that can be used in the charging station shown in FIG. 1 and includes a J1772 to non-J1772 adapter, in accordance with an exemplary embodiment of the disclosed concept;

FIG. 4A is a perspective view of the adapter shown in FIG. 3, in which a locking overmold and a locking mechanism of the adapter are shown in more detail;

FIG. 4B is a sectional view of the adapter shown in FIG. 4A, as indicated by the cutting line S1-S1 shown in FIG. 4A, with the locking mechanism of the adapter shown in an engaged position;

FIG. 4C is the same sectional view of the adapter shown in FIG. 4B, with the locking mechanism of the adapter shown in a disengaged position;

FIG. 5 is a perspective view of the improved holster arrangement shown in FIG. 3 when the adapter is set to a J1772 setting within the holster and the J1772 connector has been removed from the holster, in accordance with an exemplary embodiment of the disclosed concept;

FIG. 6 is a perspective view of the improved holster connector shown in FIG. 3 after the adapter has been locked into a non-J1772 setting and the J1772 connector has been removed from the holster with the adapter locked onto the J1772 connector in order to charge a vehicle with a non-J1772 charging port, in accordance with an exemplary embodiment of the disclosed concept; and

FIG. 7 is a side view of an improved J1772 EV connector with a split switch design for actuating a latch and a proximity switch, in accordance with an exemplary embodiment of the disclosed concept.

### DETAILED DESCRIPTION OF THE INVENTION

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts.

As employed herein, the term “charging state” shall mean a state in which electric power is being transferred from one source into another. For example and without limitation, a charging state in which a charging station is mechanically coupled and electrically connected to an EV is a state in which electric power is being transferred from the charging station into the EV.

As employed herein, the term “charging box” shall mean an apparatus having any geometry (e.g., box-shaped and non-boxed shaped geometries), and that is structured to produce an electric charge for the purpose of charging an EV.

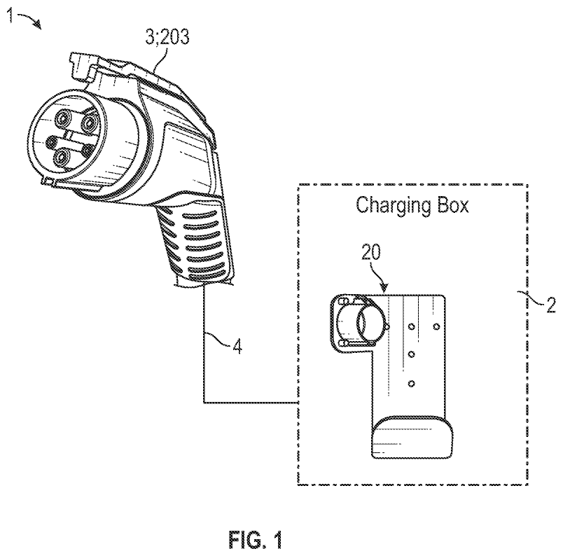

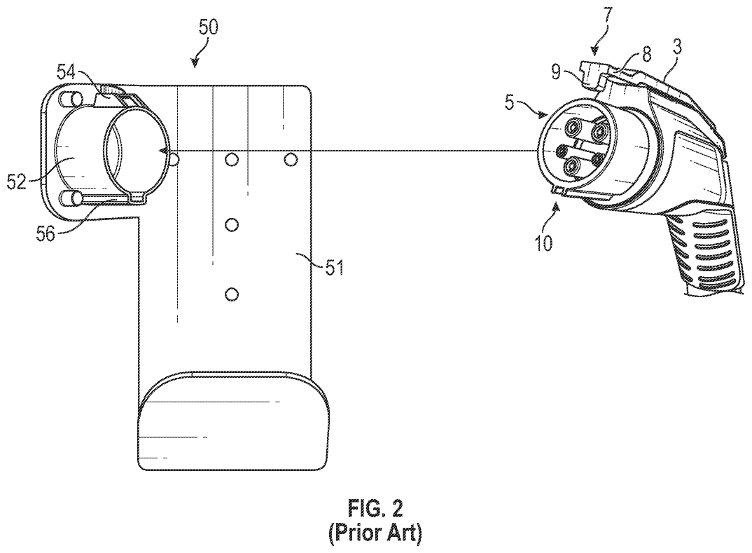

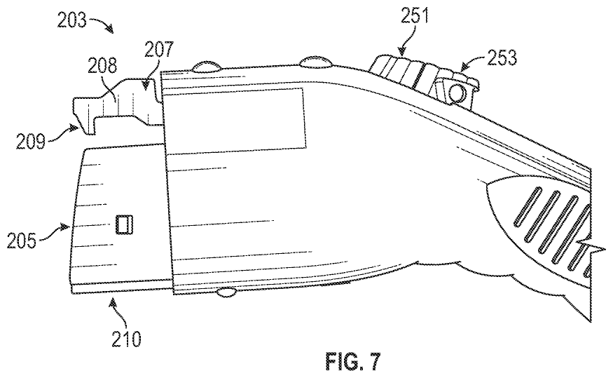

Disclosed herein is an improved holster for an EV charging connector that enables existing EV charging stations having J1772 charging connectors to be used both with vehicles having J1772 charging ports and vehicles having non-J1772 charging ports. FIG. 1 shows a simplified and schematically depicted EV charging station 1. The EV charging station 1 comprises a charging box 2 structured to be electrically connected to a power source, such as utility power. An EV charging connector 3 or 203 is electrically connected to the charging box 2 by a cable 4. The connector 3 is a prior art standard J1772 connector, and the charging connector 203 is an improved J1772 EV connector according to an exemplary embodiment of the disclosed concept that is detailed further later herein in connection with FIG. 7. In the view shown in FIG. 1, there is no difference between the prior art connector 3 and the improved EV connector 203. For the sake of simplicity, FIGS. 2-6 only reference the prior art connector 3, rather than referencing both the prior art connector 3 and the improved connector 203.

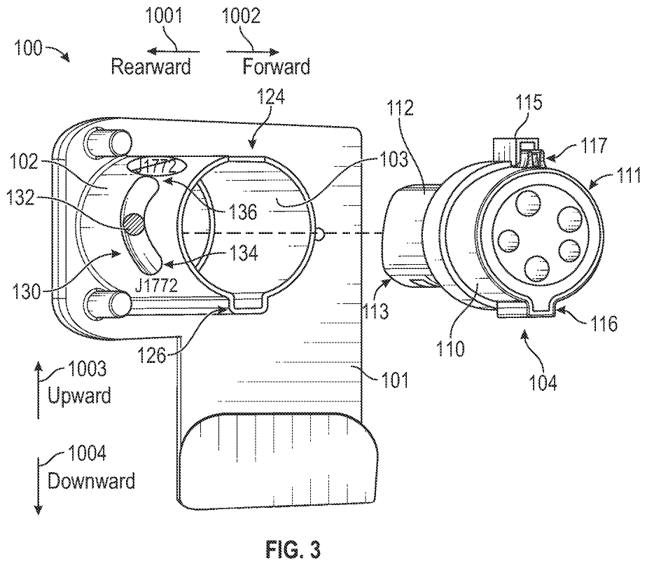

Referring now to FIG. 2 in conjunction with FIG. 1, the connector 3 includes a J1772 male charging interface 5 and is structured to be inserted into a J1772 charging port on an electric vehicle in order to charge the vehicle. The connector 3 also includes various features used to secure the connector 3 to a holster or to the charging port of a vehicle, such as a J1772 latch 7 comprising an arm 8 and an overhang 9, and a number of alignment ridges 10, which are detailed further later herein in connection with a prior art holster 50 (shown in FIG. 2) and the disclosed improved holster arrangement 100 (shown in FIGS. 3-6). The charging box 2 includes a generic holster 20 structured to secure the charging connector 3, 203 when the charging connector 3, 203 is not in use. The holster 20 shown in FIG. 1 is intended to depict a generic holster that can be replaced with either the prior art holster 50 shown in FIG. 2 or a disclosed improved holster arrangement 100 shown in FIGS. 3-6.

The prior art holster 50 shown in FIG. 2 can be included in the EV charging station 1 and used in place of the holster 20 shown in FIG. 1 in order to holster a J1772 connector such as the charging connector 3. The holster 50 comprises a base 51 structured to be coupled to the charging box 2 (for example and without limitation, using bolts or screws) and a cradle 52 that extends outward from the base 51. The cradle 52 comprises an opening structured to receive the charging interface 5, a latch stop 54 structured to engage the J1772 latch 7, and a pocket 56 structured to receive the number of ridges 10 of the connector 3.

The latch stop 54 is spaced apart from the base 51. When a user wants to holster the connector 3, the user must first press a latch lift/release button (not visible in FIG. 2) on the connector 3 that lifts the J1772 latch 7 upward and then insert the connector 3 into the cradle 52 with the charging interface 5 facing toward the base 51 and with the number of alignment ridges 10 inserted into the pocket 56. After the connector 3 is fully inserted into the cradle 52, the user can release the latch lift/release button, which releases the J1772 latch 7 down so that the overhang 9 is positioned at the rear side of the latch stop 54 (i.e. between the base 51 and the latch stop 54). The latch stop 54 obstructs the overhang 9 from moving forward past the latch stop 54 so that the connector 3 can only be removed from the cradle if the user presses the latch lift/release button to lift the cradling J1772 latch 7 upward and pulls the connector 3 forward out of the cradle 52.

Referring now to FIG. 3, an improved holster arrangement 100 that includes a J1772 to non-J1772 adapter 104 is shown in accordance with exemplary embodiments of the disclosed concept. The holster arrangement 100 is structured to hold and secure a J1772 connector such as the charging connector 3 shown in FIG. 1. The holster arrangement 100 comprises a base 101 structured to be coupled to the charging box 2 shown in FIG. 1 (for example and without limitation, using bolts or screws), a cradle 102 that extends outward from the base 101 and comprises a cradle wall 103, and a J1772 to non-J1772 adapter 104. The side of the cradle 102 that is coupled to the holster base 101 will be referred to herein as the rear side of the cradle 102, and the side of the cradle 102 disposed opposite the rear side will be referred to herein as the front side of the cradle 102.

For case of description, the directions/orientations “rearward”, “frontward”, “upward”, and “downward” are indicated in FIG. 3 in by the respective arrows 1001, 1002, 1003, and 1004. These directions/orientations are used throughout the subsequent figures and referred to throughout the description herein in order to provide a frame of reference from one figure to another, and in order to provide orientations for each of the components relative to one another. It will be appreciated that the term “rear” is used herein to refer to the portion of a component that is as rearward 1001 on the component as possible, the term “front” is used herein to refer to the portion of a component that is as frontward 1002 on the component as possible, the term “top” is used herein to refer to the portion of a component that is as upward 1003 on the component as possible, and the term “bottom” is used herein to refer to the portion of a component that is as downward 1004 on the component as possible.

The J1772 to non-J1772 adapter 104 is referred to hereinafter as the “adapter 104” for brevity. The adapter 104 comprises a first section 110 that comprises a first side 111 with a J1772 female interface and a second section 112 that comprises a second side 113 with a non-J1772 interface disposed opposite the first side 111. The first section 110 can accordingly be referred to as the “J1772 section 110” and the second section 112 can accordingly be referred to as the “non-J1772 section 112”. Similarly, the first side 111 can accordingly be referred to as the “J1772 interface 111” and the second side 113 can accordingly be referred to herein as the “non-J1772 interface 113”.

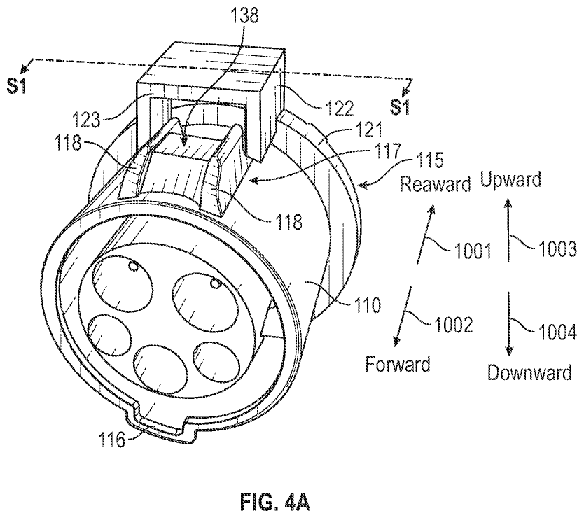

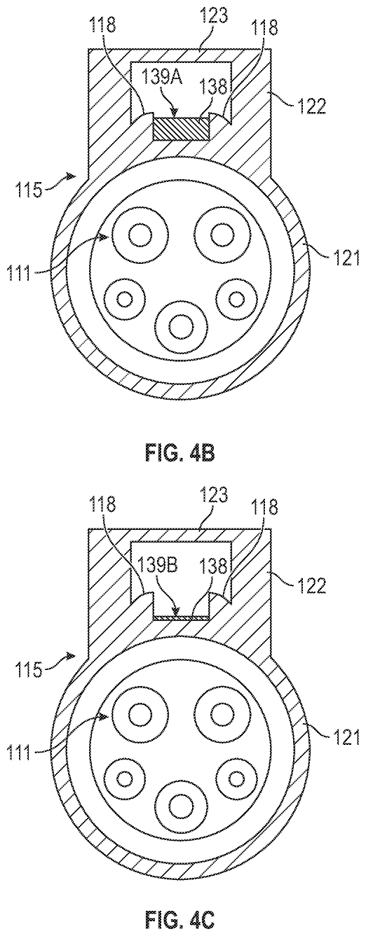

It should be noted that, although the adapter 104 is shown disposed outside of the cradle 102 in FIG. 3 and FIGS. 4A-4C in order to better show various features of the adapter 104 and the cradle 102, the cradle 102 and adapter 104 are structured to enable the adapter 104 to be removed from the cradle 102 only when the adapter 104 is locked onto the connector 3, as detailed further later herein. Otherwise, the adapter 104 remains seated within and locked into the cradle 102. That is, the cradle 102 and the adapter 104 are structured to ensure that the adapter 104 is always locked into either a first state or a second state, with the first state being one in which the adapter 104 is seated in and locked into the cradle 102, and the second state being one in which the adapter 104 is locked onto the connector 3. Both the first state and the second state are detailed further later herein.

When reference is made herein to the “seated and locked adapter 104” or when it is stated that the adapter 104 is “seated and locked” into the cradle 102, this denotes that the adapter 104 is seated within and locked into the cradle 102 (as opposed to being locked onto the connector 3 and removed from the cradle 102). Conversely, when reference is made herein to the “locked-on adapter 104”, this denotes that the adapter 104 is locked onto the connector 3 (either within the cradle 102 or outside of the cradle 102).

Referring now to FIGS. 4A-4C in conjunction with FIG. 3, the adapter 104 additionally comprises a locking overmold 115. As can be seen in FIG. 3 and FIG. 4A, the J1772 section 110 has a profile that is predominately circular, with two protrusions extending outward from the circular profile, the two protrusions including an alignment pocket 116 and a latch receiver 117. The alignment pocket 116 is structured to receive the alignment ridges 10 of the connector 3 when the connector 3 is inserted into the adapter 104, and the latch receiver 117 is structured to receive the connector's J1772 latch overhang 9 when the connector 3 is inserted into the adapter 10. In an exemplary embodiment of the disclosed concept, as shown in FIG. 4A, the latch receiver 117 comprises two ridges 118 spaced apart from one another (numbered in FIG. 14A), with the distance between the ridges 118 being slightly wider than the width of the connector's latch overhang 9 (FIG. 2) so that the latch overhang 9 can be received in between the ridges 118 when the connector 3 is inserted into the adapter 104, as detailed further later herein. The locking overmold 115 comprises a circular portion 121 and an extension portion 122 that extends upward 1003 from the top side of the circular portion 121. The circular portion 121 snugly surrounds the J1772 section 110 at a position that is rearward 1001 relative to the rear end of the alignment pocket 116, such that the circular portion 121 contacts the circular profile of J1772 section 110 while the extension portion does not contact the circular profile. The extension portion 122 comprises a top wall 123 that is positioned a distance above the top edges (not numbered) of the ridges 118.

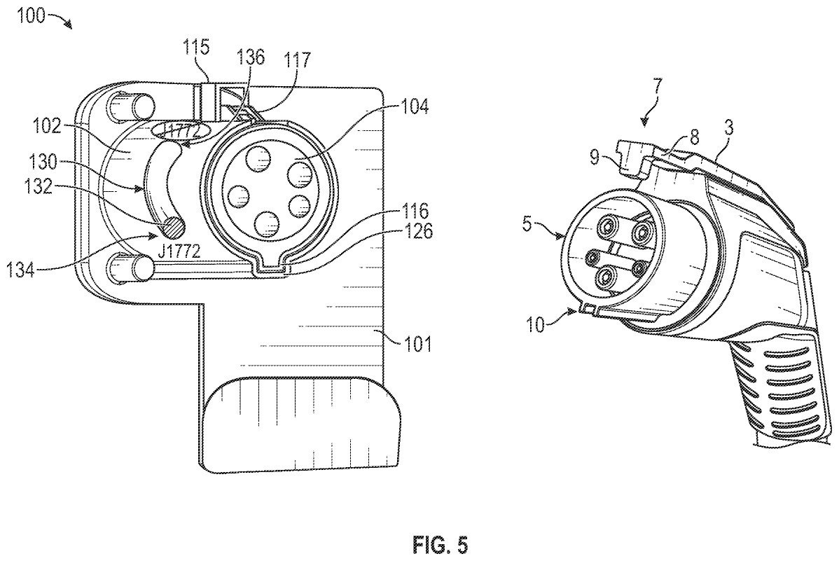

The top side of the cradle 102 is formed with a slot 124 (FIG. 3) structured to receive the extension portion 122 of the locking overmold 115 (as shown in FIG. 5), with the slot 124 being a gap formed in the cradle wall 103. As previously noted, the adapter 104 includes an alignment pocket 116, so the cradle 102 is accordingly formed with a pocket receiver 126 structured to receive the alignment pocket 116. Thus, when the adapter 104 is seated and locked into the cradle 102, the slot 124 receives the extension portion 122 of the overmold 115, and the pocket receiver 126 receives the alignment pocket of the adapter 104. When the adapter 104 is seated and locked into the cradle 102, the extension portion 122 of the overmold 115 extends upward through the slot 124 to the exterior of the cradle 102.

The cradle 102 and adapter 104 are each structured such that, when the adapter 104 is inserted into the cradle 102, the adapter 104 must be inserted with the non-J1772 interface 113 facing toward the holster base 101, resulting in the J1772 interface 111 facing forward away from the base 101 and being accessible at the front of the cradle 102 by a user. The J1772 interface 111 is structured to receive the charging connector 3 such that the charging interface 5 can be inserted into the adapter's J1772 interface 111 in order to couple the charging connector 3 to the adapter 104. Thus, the connector 3 can be coupled to the seated and locked adapter 104 in order to holster the connector 3 in the cradle 102 when the connector 3 is not in use.

Continuing to refer to FIGS. 3 and 4A-4C, the cradle 102 and adapter 104 comprise several features, including the locking overmold 115, that cooperate with features of the connector 3 in order to secure the connector 3 within the adapter 104 and in order to secure the adapter 104 within the cradle 102 when holstering the connector 3 in the holster arrangement 100. One such feature is a mode selection mechanism 130 included in the cradle 102. The mode selection mechanism 130 comprises a mode selection actuator 132 that can be manually actuated between being set on a J1772 setting 134 and being locked into a non-J1772 setting 136. As detailed further later herein, the mode selection actuator 132 is configured to engage a locking mechanism 138 (FIGS. 4A-4C) of the adapter 104 such that actuating the mode selection actuator 132 actuates a locking mechanism 138 of the adapter 104 between a disengaged position and an engaged position, with the disengaged position corresponding to being set on the J1772 setting 134 and the engaged position corresponding to being locked into the a non-J1772 setting 136.

If the mode selection actuator 132 is not locked into the non-J1772 setting 136, then the mode selection actuator 132 is considered to be set on the J1772 setting 134. For example, in the figures, the mode selection actuator 132 is depicted as being a button that can be pushed/slid along a track, and in FIG. 3, the button of the mode selection actuator 132 is not pushed all the way toward the non-J1772 setting 136, therefore, the mode selection actuator 132 is set on the J1772 setting 134. In another exemplary embodiment, the mode selection actuator 132 can instead comprise a key that is permanently mounted on the cradle 102, wherein pushing the key in and turning it in one direction (e.g. to the right) locks the mode selection actuator 132 into the non-J1772 setting 136 and thus locks the adapter 104 onto the connector 3, and wherein pushing the key in and turning it to the opposite direction (e.g. to the left) releases the mode selection actuator 132 from the non-J1772 setting 136 and thus releases the adapter 104 from the connector 3. The depiction of the mode selection mechanism 130 being disposed on the side of the cradle 102 is intended to be illustrative in nature, and it should be noted that the mode selection mechanism 130 can be disposed elsewhere on the cradle 102 without departing from the scope of the disclosed concept.

As noted above, the mode selection mechanism 130 is structured to actuate a locking mechanism 138 (FIGS. 4A-4C) of the adapter 104, enabling the locking overmold 115 and locking mechanism 138 to effectuate locking of the adapter 104 onto the connector 3. The mode selection mechanism 130 is structured to actuate the locking mechanism 138 to move between an engaged position 139A (as shown and numbered in FIG. 4B, also shown in FIG. 4A but not numbered) and a disengaged position 139B (as shown and numbered in FIG. 4C), such that the locking mechanism 138 extends outward from the circular profile of the J1772 section 110 when in the engaged position 139A and recedes inward toward the circular profile of the J1772 section 110 when in the disengaged position 139B. More specifically, when the mode selection mechanism 130 is set on the J1772 setting 134, the locking mechanism 138 is disposed in the disengaged position 139B (FIG. 14C), and when the mode selection mechanism 130 is locked into the non-J1772 setting 136, the locking mechanism 138 is disposed in the engaged position 139A (FIG. 14B). Hereinafter, when it is stated that the locking mechanism is in the engaged position 139A, it should be understood that the mode selection mechanism 130 is necessarily locked into the non-J1772 setting 136, and when it is stated that the locking mechanism is in the disengaged position 139B, it should be understood that the mode selection mechanism 130 is necessarily set on the J1772 setting 134.

When the adapter 104 is seated and locked into the cradle 102 and a user wants to holster the connector 3 using the holster arrangement 100, the locking mechanism 138 must be in the disengaged position 139B, i.e the mode selection mechanism 130 must be set on the J1772 setting 134. When the locking mechanism 138 is in the disengaged position 139B, the user can simply insert the connector 3 into the seated and locked adapter 104. When the locking mechanism 138 is in the disengaged position 139B and the user inserts the connector 3 into the seated and locked adapter 104, the latch overhang 9 (FIG. 2) slides through the two ridges 118 of the latch receiver 117. The latch receiver 117 is proportioned such that, when the connector 3 is fully inserted into the adapter 104, the connector's cradling latch overhang 9 is positioned rearward 1001 relative to the locking mechanism 138.

Both the locking mechanism 138 and the extension portion 122 are used to lock the adapter 104 onto the connector 3. When the connector 3 is fully inserted into the seated and locked adapter 104 and the mode selection mechanism 130 is subsequently actuated to lock into the non-J1772 setting 136 (thus causing the locking mechanism 138 to be actuated to the engaged position 139A), the connector's latch overhang 9 (FIG. 2) is positioned rearward 1001 of the locking mechanism 138 and the locking mechanism 138 obstructs the latch overhang 9 from being able to move forward past the locking mechanism 138. In addition, the overmold's extension portion 122 (FIG. 4A) is specifically proportioned so that, when the locking mechanism 138 is in the engaged position 139A, a top wall 123 (FIG. 4A) of the extension portion 122 is positioned far enough upward 1003 of the top side of the locking mechanism 138 that the connector's latch arm 8 (FIG. 5) fits in the space between the locking mechanism 138 and the top wall 123, but also so that the top wall 123 is positioned close enough to the top side of the locking mechanism 138 to prevent the latch arm 8 from moving far enough upward 1003 to enable the overhang 9 to clear the top surface of the locking mechanism 138 in the event that a user presses the latch lift/release button of the connector 3 and pulls forward 1002 on the connector 3, thus preventing the adapter 104 from being uncoupled from the connector 3. Accordingly, when the mode selection mechanism 130 is locked onto the non-J1772 setting 136 with the connector 3 holstered in the cradle 102 and a user pulls the connector 3 forward out of the cradle 102, the adapter 104 gets locked onto the connector 3, such that only the non-J1772 interface 113 is accessible.

Referring now to FIG. 5, as previously stated, the cradle 102 and adapter 104 are further structured such that, when the adapter 104 is seated in the cradle 102 and the mode selection actuator 132 is not locked into the non-J1772 setting 136, then the adapter 104 is locked into the cradle 102. In addition, the cradle 102 and adapter 104 are also structured such that the mode selection actuator 132 can only be actuated to be locked into the non-J1772 setting 136 when: (1) the adapter 104 is seated in and locked into the cradle 102, and (2) the charging connector 3 is coupled to the adapter 104 (i.e. when the charging interface 5 is inserted into the J1772 female interface 111 of the adapter 104). That is, the adapter 104 cannot be removed from the cradle 102 unless the adapter 104 is locked onto the connector 3. When the connector 3 is holstered in the cradle 102 and an EV having a J1772 charging port needs to be charged, the mode selection actuator 132 can be set to the J1772 setting 134 (i.e. such that the locking mechanism 138 is in the disengaged position 139A), and the user can simply pull forward on the connector 3 to remove the connector 3 from the seated and locked adapter 104, and the adapter 104 will remain seated within and locked into the cradle 102, as shown in FIG. 5.

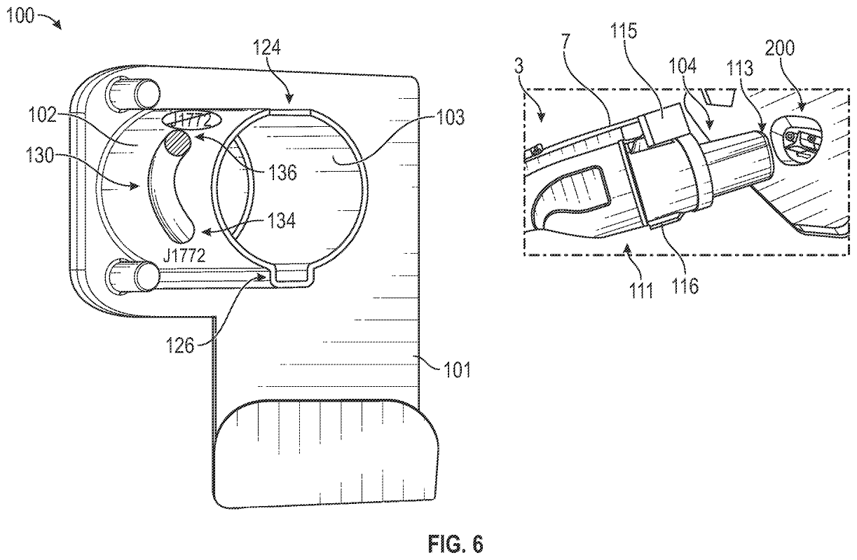

Referring now to FIG. 6, when an EV having a non-J1772 charging port 200 needs to be charged, the user can move the mode selection actuator 132 to lock onto the non-J1772 setting 136 and then pull the charging connector 3 forward out of the cradle 102, and the adapter 104 will be locked onto the connector 3. It will be appreciated that when the adapter 104 is locked onto the connector 3, the non-J1772 interface 113 of the adapter 104 is accessible and the connector 3 can be inserted into the charging port 200 of the EV via the non-J1772 interface 113, as shown in the figure. It should be noted that, when connector 3 is removed from cradle 102 with adapter 104 locked onto it, the mode selection actuator 132 cannot be moved from the non-J1772 setting 136, and that the connector 3 with the locked-on adapter 104 must be inserted back into the cradle 102 in order for the mode selection actuator 132 to be moved from the non-J1772 setting 136.

There are several advantages offered by the disclosed improved holster arrangement 100. For the many EV charging station hosts who only have J1772 connectors, the improved holster arrangement 100 allows the charging station hosts to simply replace their existing prior art holsters (such as the prior art holster 50 shown in FIG. 2) with the improved holster arrangement 100 in order to accommodate both J1772-enabled and non-J1772-enabled vehicles. It is apparent that replacing the prior art holsters 50 with the improved holster arrangement 100 is much simpler and less costly than the J1772 charging station hosts having to decide whether to add new non-J1772 connectors and charging boxes, whether to replace any of the existing J1772 connectors with non-J1772 connectors, and/or how many J1772 and non-J1772 connectors to provide. In addition, structuring the cradle 102 and the adapter 104 such that the adapter can only be either seated within and locked into the cradle 102 or locked onto the connector 3 ensures that the adapter 104 cannot be removed from the cradle 102 unless it is coupled to the charging connector 3, thus preventing vandalism, theft, and/or accidental loss of the adapter 104.

Reference is now made to FIG. 7, which shows an improved EV connector 203 that can further optimize the features of the holster arrangement 100, in accordance with an exemplary embodiment of the disclosed concept. For example and without limitation, the EV connector 203 can be used in the EV charging station 1 with the holster arrangement 100. The EV connector 203 includes all of the features of the prior art connector 3 shown in FIGS. 2 and 5, and the features of the EV connector 203 that are the same as the features of the prior art connector 3 are numbered with numbers similar to those used for the prior art connector 3, just incremented by 200. The connector 203 is structured to be used with the holster arrangement 100 in the same manner as previously described herein in connection with the connector 3.

It is noted that the arm 208 and overhang 209 of the EV connector 203 have a somewhat different structure than the arm 8 and overhang 9 of the prior art connector 3, as the arm 8 and overhang 9 have a more planar profile when viewed from the side than the arm 208 and overhang 209 do, and it is further noted that such structural variations among the arms and overhangs of the latches of J1772 connectors produced by different manufacturers are common. However, for a given J1772 connector, as long as the arm and overhang of the J1772 connector are proportioned to engage the appropriate portion of the J1772 charging port on a vehicle, then the other features of the arm and overhang do not affect the ability of the arm and overhang to collectively function as a J1772 latch. Thus, the EV connector 203 can be produced with its arm 208 structured more similarly to the arm 8 of the connector 3 (or another design) and with its overhang 209 structured more similarly to the overhang 9 of the connector 3 (or another design), without departing from the scope of the disclosed concept.

The latch lift/release button (not shown in the figures) of the connector 3 has been previously referred to herein in the context of needing to be actuated in order to lift the J1772 latch 7 upward, but it should be noted that the latch lift/release button of the connector 3 is also necessary in order to actuate a proximity pin of the connector 3. All J1772 EV connectors and all non-J1772 EV connectors include a proximity pin that is configured to communicate with an electrical vehicle when the J1772 or non-J1772 EV connector is inserted into the vehicle. In particular, when the connector 3 is connected to the charging port of an electric vehicle during a charging operation and a user wants to stop the charging operation, the user must actuate the latch lift/release button in order to actuate the proximity pin (i.e. change the state of the proximity pin). Actuating the proximity pin instructs the vehicle to stop drawing current, so that the connector 3 can be removed from the vehicle's charging port without causing arcing. The prior art connector 3 only includes a single latch lift/release button. In contrast, the disclosed EV connector 203 implements a split switch design and includes two switches, a latch/proximity switch 251 and a proximity-only switch 253. The latch/proximity switch 251 is configured to operate in the same manner as the single lift/latch release button of the connector 3, i.e. such that actuating the latch/proximity switch 251 both lifts the latch 207 and actuates the proximity pin of the connector 203. In contrast, the proximity-only switch 253 is configured to only operate the proximity pin of the connector 203, i.e. such that actuating the proximity-only switch 253 only changes the state of the proximity pin of the connector 203 without actuating the latch 207.

Still referring to FIG. 7, the proximity-only switch 253 is particularly useful when the adapter 104 is locked onto the connector 203 in order to charge an electric vehicle with a non-J1772 charging port. While the extension portion 122 of the overmold 115 can be proportioned to enable the adapter 104 to be suitable for use with a prior art connector 3, it is noted that, when the adapter 104 is used with a prior art connector 3, the extension portion 122 of the overmold 115 must have fairly specific proportions. As previously stated, the overmold's top wall 123 is positioned close enough to the top side of the locking mechanism 138 to prevent the overhang 9 of the J1772 latch arm 8 from clearing the top surface of the locking mechanism 138 in the event that a user presses the latch lift/release button of the connector 3 when the adapter 104 is locked onto the connector 3. However, if the adapter 104 is being used to enable the prior art connector 3 to charge a vehicle with a non-J1772 charging port, the top wall 123 of the adapter 104 also has to be positioned far enough upward 1003 to enable the latch 7 to move far enough upward 1003 when a user needs to actuate the proximity pin of the connector 3 in order to stop a charging operation.

In comparison, the split-switch design of the disclosed EV connector 203 imposes fewer restrictions on the positioning of the top adapter's top wall 123. Specifically, when the adapter 104 is produced for use with the disclosed connector 203, the only requirement for the top wall 123 of the overmold 115 is that the top wall 123 be positioned close enough to the locking mechanism 138 to prevent the latch's overhang 209 from clearing the locking mechanism 138 in the event that user actuates the latch/proximity switch 251, without requiring that the top wall 123 be positioned far enough upward 1003 to enable actuation of the proximity pin via actuation of the latching arm 207, since the proximity-only switch 253 can be used to actuate the proximity pin of the connector 203 when the user wishes to stop the vehicle from drawing current from the connector 203.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A holster arrangement for use with an EV charging station, the holster arrangement being structured to secure a J1772 connector in place when the J1772 connector is not being used for charging, the holster arrangement comprising:
a base;
a cradle extending from the base; and
an adapter structured to be coupled to a charging interface of the J1772 connector, the adapter comprising:
a J1772 interface; and
a non-J1772 interface disposed opposite the J1772 interface,
wherein the cradle and the adapter are structured to ensure that the adapter is always locked into either a first state or a second state,
wherein, in the first state, the adapter is seated in and locked into the cradle,
wherein, in the second state, the adapter is locked onto the J1772 connector, and
wherein the adapter is structured to enable an electric vehicle with a non-J1772 charging port to be charged by the J1772 connector when the adapter is coupled to the J1772 connector.

2. The holster arrangement of claim 1,
wherein the cradle and the adapter are structured such that the adapter can only be removed from the cradle if the adapter is locked onto the J1772 connector.

3. The holster arrangement of claim 2,
wherein the cradle further comprises a mode selection mechanism,
wherein the mode selection mechanism comprises a mode selection actuator that can be actuated between a J1772 setting and a non-J1772 setting,
wherein the cradle and the adapter are structured such that the mode selection actuator can only be actuated from the J1772 setting to the non-J1772 setting if the adapter is seated in and locked into the cradle and if the J1772 connector is coupled to the adapter, and
wherein the mode selection mechanism and the adapter are structured such that setting the mode selection actuator to the non-J1772 setting locks the adapter onto the J1772 connector.

4. The holster arrangement of claim 3,
wherein the mode selection mechanism is structured such that, when the mode selection actuator is actuated to the non-J1772 setting such that the adapter gets locked onto the J1772 connector and the J1772 connector with the locked-on adapter is removed from cradle, the mode selection actuator cannot be actuated out of the non-J1772 setting.

5. The holster arrangement of claim 3,
wherein the adapter comprises a lock mechanism structured to be actuated by the mode selection actuator such that actuating the mode selection actuator to the non-J1772 setting actuates the lock mechanism to an engaged position and such that actuating the mode selection actuator to the J1772 setting actuates the lock mechanism to a disengaged position,
wherein the lock mechanism is structured such that, when the lock mechanism is in the engaged position, the lock mechanism prevents a latch of the J1772 connector from moving forward out of the adapter.

6. The holster arrangement of claim 5,
wherein the adapter comprises an overmold,
wherein the adapter comprises a J1772 section and the J1772 interface is included in the J1772 section,
wherein the J1772 section has a circular profile with a latch receiver extending outward from the circular profile, the latch receiver being structured to receive the latch of the J1772 connector when the adapter is locked onto the J1772 connector,
wherein the overmold surrounds a portion of the circular profile of the J1772 section and a portion of the latch receiver, and
wherein the overmold comprises an extension portion that is structured to prevent the latch from moving far enough upward for an overhang of the latch to be positioned higher than the lock mechanism when the adapter is locked onto the J1772 connector.

7. An EV charging station for charging electric vehicles, the EV charging station comprising:
a J1772 connector configured to charge electric vehicles; and
a holster arrangement structured to secure the J1772 connector in place when the J1772 connector is not being used for charging, the holster arrangement comprising:
a base;
a cradle extending from the base; and
an adapter structured to be coupled to a charging interface of the J1772 connector, the adapter comprising:
a J1772 interface; and
a non-J1772 interface disposed opposite the J1772 interface,
wherein the cradle and the adapter are structured to ensure that the adapter is always locked into either a first state or a second state,
wherein, in the first state, the adapter is seated in and locked into the cradle,
wherein, in the second state, the adapter is locked onto the J1772 connector, and
wherein the adapter is structured to enable an electric vehicle with a non-J1772 charging port to be charged by the J1772 connector when the adapter is coupled to the J1772 connector.

8. The EV charging station of claim 7,
wherein the cradle and the adapter are structured such that the adapter can only be removed from the cradle if the adapter is locked onto the J1772 connector.

9. The EV charging station of claim 8,
wherein the cradle further comprises a mode selection mechanism,
wherein the mode selection mechanism comprises a mode selection actuator that can be actuated between a J1772 setting and a non-J1772 setting,
wherein the cradle and the adapter are structured such that the mode selection actuator can only be actuated from the J1772 setting to the non-J1772 setting if the adapter is seated in and locked into the cradle and if the J1772 connector is coupled to the adapter, and
wherein the mode selection mechanism and the adapter are structured such that setting the mode selection actuator to the non-J1772 setting locks the adapter onto the J1772 connector.

10. The EV charging station of claim 9,
wherein the mode selection mechanism is structured such that, when the mode selection actuator is actuated to the non-J1772 setting such that the adapter gets locked onto the J1772 connector and the J1772 connector with the locked-on adapter is removed from cradle, the mode selection actuator cannot be actuated out of the non-J1772 setting.

11. The EV charging station of claim 9,
wherein the adapter comprises a lock mechanism structured to be actuated by the mode selection actuator such that actuating the mode selection actuator to the non-J1772 setting actuates the lock mechanism to an engaged position and such that actuating the mode selection actuator to the J1772 setting actuates the lock mechanism to a disengaged position,
wherein the lock mechanism is structured such that, when the lock mechanism is in the engaged position, the lock mechanism prevents a latch of the J1772 connector from moving forward out of the adapter.

12. The EV charging station of claim 9,
wherein the adapter comprises an overmold,
wherein the adapter comprises a J1772 section and the J1772 interface is included in the J1772 section,
wherein the J1772 section has a circular profile with a latch receiver extending outward from the circular profile, the latch receiver being structured to receive the latch of the J1772 connector when the adapter is locked onto the J1772 connector,
wherein the overmold surrounds a portion of the circular profile of the J1772 section and a portion of the latch receiver, and
wherein the overmold comprises an extension portion that is structured to prevent the latch from moving far enough upward for an overhang of the latch to be positioned higher than the lock mechanism when the adapter is locked onto the J1772 connector.

13. The EV charging station of claim 12,
wherein the J1772 connector includes a proximity-only switch,
wherein the proximity-only switch is configured such that actuation of the proximity-only switch changes a state of a proximity pin of the J1772 connector without actuating the latch.

14. The EV charging station of claim 13,
wherein the J1772 connector includes a latch/proximity switch in addition to the proximity-only switch,
wherein the latch/proximity switch is configured such that actuation of the latch/proximity switch simultaneously lifts the latch and changes a state of a proximity pin of the J1772 connector.

15. An adapter for use with a holster arrangement of an EV charging station, the EV charging station including a J1772 connector, the holster arrangement being structured to secure the J1772 connector in place when the J1772 connector is not being used for charging, the adapter comprising:
a J1772 interface; and
a non-J1772 interface disposed opposite the J1772 interface,
wherein the adapter is structured to cooperate with a cradle of the holster arrangement in order to always be locked into either a first state or second state,
wherein, in the first state, the adapter is seated in and locked into the cradle,
wherein, in the second state, the adapter is locked onto the J1772 connector, and
wherein the adapter is structured to enable an electric vehicle with a non-J1772 charging port to be charged by the J1772 connector when the adapter is coupled to the J1772 connector.

16. The adapter of claim 15,
wherein the adapter is structured to only be removed from the cradle if the adapter is locked onto the J1772 connector.

17. The adapter of claim 16,
wherein the adapter is structured to be actuated between the first state and the second state by actuation of a mode selection mechanism of the cradle, and
wherein the adapter is structured such that the adapter can only be actuated from the first state to the second state if the adapter is seated in and locked into the cradle and if the J1772 connector is coupled to the adapter.

18. The adapter of claim 17,
wherein the adapter comprises a lock mechanism structured to be actuated by the mode selection actuator such that actuation of the adapter to the second state actuates the lock mechanism to an engaged position and such that actuation of the adapter to the first state actuates the lock mechanism to a disengaged position,
wherein the lock mechanism is structured such that, when the lock mechanism is in the engaged position, the lock mechanism prevents a latch of the J1772 connector from moving forward out of the adapter.

19. The adapter of claim 18,
wherein the adapter comprises an overmold,
wherein the adapter comprises a J1772 section and the J1772 interface is included in the J1772 section,
wherein the J1772 section has a circular profile with a latch receiver extending outward from the circular profile, the latch receiver being structured to receive the latch of the J1772 connector when the adapter is locked onto the J1772 connector,
wherein the overmold surrounds a portion of the circular profile of the J1772 section and a portion of the latch receiver, and
wherein the overmold comprises an extension portion that is structured to prevent the latch from moving far enough upward for an overhang of the latch to be positioned higher than the lock mechanism when the adapter is locked onto the J1772 connector.
